(19) United States
(12) Patent Application Publication
(10) Pub. No.: US 2012/0217302 A1
(43) Pub. Date: Aug. 30, 2012

(54) CODE SYMBOL READING APPARATUS AND METHOD FOR READING CODE SYMBOL

(75) Inventors: Hidehiro Naito, Shizuoka-ken (JP); Yoshiya Yamada, Shizuoka-ken (JP)

(73) Assignee: TOSHIBA TEC KABUSHIKI KAISHA, Tokyo (JP)

(21) Appl. No.: 13/369,412

(22) Filed: Feb. 9, 2012

(30) Foreign Application Priority Data
Feb. 24, 2011 (JP) 2011-038891

(51) Int. Cl. G06K 7/14

(52) U.S. Cl. 235/455

(57) ABSTRACT

According to the embodiment, a code symbol reading apparatus includes an image photography section configured to photograph image of a code symbol, a reading section configured to read out the code symbol from image photographed by the image photography section, a light source configured to radiate light to an image photography area for a first prescribed period in synchronism with at least a part of a period during which image is photographed and radiate light to the image photography area for the first prescribed period at prescribed intervals while image is not photographed and a control section configured to set a period for which light is radiated in synchronism with at least a part of the period during which image is photographed to a second prescribed period shorter than the first prescribed period if brightness of image photographed is equal to or greater than a preset brightness value.

### CROSS-REFERENCE TO RELATED APPLICATION

This application is based upon and claims the benefit of priority from the prior Japanese Patent Application No. 2011-038891, filed on Feb. 24, 2011, the entire contents of all of which are incorporated herein by reference.

### FIELD

Embodiments described herein relate generally to a code symbol reading apparatus and a method for reading a code symbol.

### BACKGROUND

A code symbol reading apparatus which photographs a code symbol such as a bar-code by an area image sensor, e.g., CCD (Charge Coupled Device) image photography element and the like and outputs an article code corresponding to the bar-code performs an image photography such that light is radiated from a light source to an image (bar-code) in synchronism with a photography action to the image by the area image sensor. In such a reading apparatus, there is an apparatus which radiates light at prescribed intervals so that human's eyes are under illusion that light is always radiated from the light source while also, the image is not photographed by the area image sensor.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention, wherein:

FIG. 1 is an external perspective view illustrating structure of a checkout lane system including a code symbol reading apparatus according to a first embodiment;

FIG. 2 is an external perspective view illustrating brief construction of the code symbol reading apparatus shown in FIG. 1;

FIG. 3 is a block diagram illustrating an organization of the code symbol reading apparatus shown in FIG. 2;

FIG. 4 is a block diagram illustrating a functional structure of the code symbol reading apparatus shown in FIG. 3;

FIG. 5 is a timing chart illustrating an output timing of a strobe signal and a light control signal in the code symbol reading apparatus shown in FIG. 3;

FIG. 6 is a view illustrating a flow of an image capture process by the code symbol reading apparatus;

FIG. 7 is a timing chart illustrating an output timing of a light control signal in respective four lighting modes of the code symbol reading apparatus; and

FIG. 8 is a flowchart illustrating a flow of an image capture process in the code symbol reading apparatus according to a second embodiment.

### DETAILED DESCRIPTION

In general, according to one embodiment, it is to provide a code symbol reading apparatus including an image photography section configured to photograph an image of a code symbol, a reading section configured to read out the code symbol from the image photographed by the image photography section, a light source configured to radiate light to an image photography area for a prescribed period in synchronism with at least a part of a period during which the image is photographed by the image photography section and radiate light to the image photography area for a prescribed period at prescribed intervals while the image is not photographed by the image photography section, and a control section configured to shorten from the prescribed period a period for which light is radiated to the image photography area in synchronism with at least a part of a period during which the image is photographed by the image photography section if brightness of the image photographed by the image photography section is equal to or greater than a preset brightness value.

Embodiments will now be described in more detail with reference to the accompanying drawings. However, the same numerals are applied to the similar elements in the drawings, and therefore, the detailed descriptions thereof are not repeated.

### First Embodiment

According to the first embodiment, brightness of an image can be changed without changing intensity of light radiated to an image photography area. Therefore, when the image is photographed, brightness of the image can be changed in a state that human's eyes are under illusion that light is always radiated.

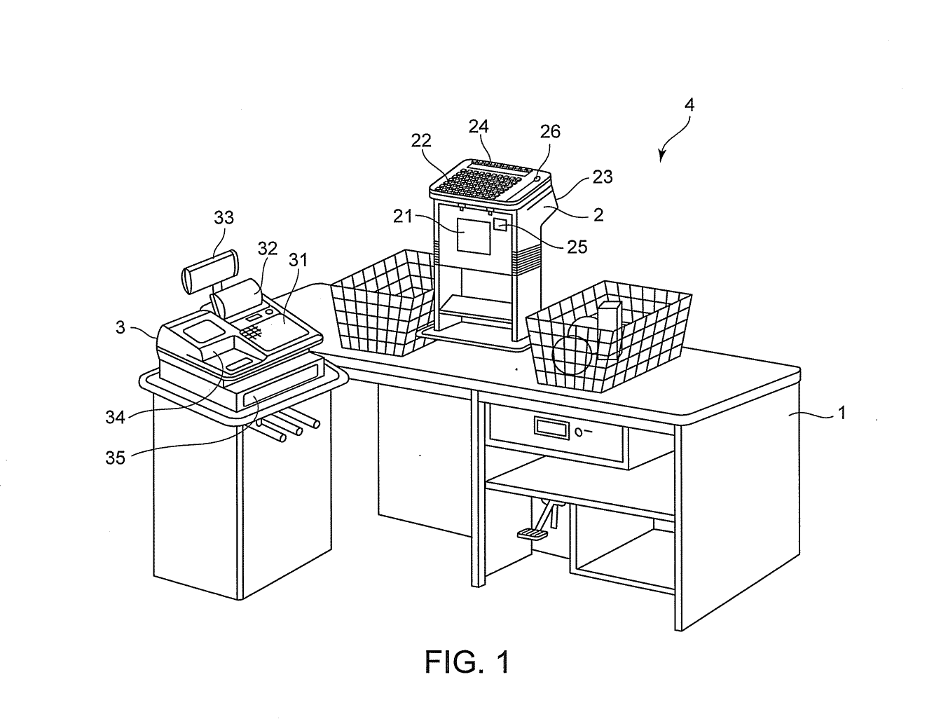

FIG. 1 is an external perspective view showing a code symbol reading apparatus having a checkout lane system according to the first embodiment. As shown in FIG. 1, the checkout lane system 4 includes a checkout table 1 that a basket into which articles to be purchased are put is placed, a code symbol reading apparatus 2 standing at a center of the checkout table 1, a POS (Point Of Sale) terminal 3 connecting with the code symbol reading apparatus 2 via a data transmission path (not shown) to be capable to mutually communicate with the code symbol reading apparatus 2.

The POS terminal 3 has a function to perform a sales-registration of articles purchased by a customer. As shown in FIG. 1, the POS terminal 3 is composed of a key board 31 serving as an input means, a first display 32 for an operator, a second display 33 for a customer, a printer 34 which carries out a receipt printing, and a drawer 35 which stores hard and paper currency. The key board 31 includes plural keys having a closing key which is required to settle a payment. The POS terminal 3 has functions similar to that of a known POS terminal.

The code symbol reading apparatus 2 reads, for example, a bar-code attached to an article and outputs article information that the bar-code represents to the POS terminal 3. The code symbol reading apparatus 2 may read a two-dimensional symbol despite the above. As shown in FIG. 1, the code symbol reading apparatus 2 includes a read-out window 21, a key board 22, a display for a customer 23, a display for an operator 24, a buzzer 25 and an LED indicator 26.

The key board 22 includes plural kinds of keys including numerical keys to be used to register an article to which a bar-code can not be attached. The display for a customer 23 displays name and price of the registered article to a customer or a shop clerk. The display for an operator 24 displays name and price of an article or an error message to an operator.

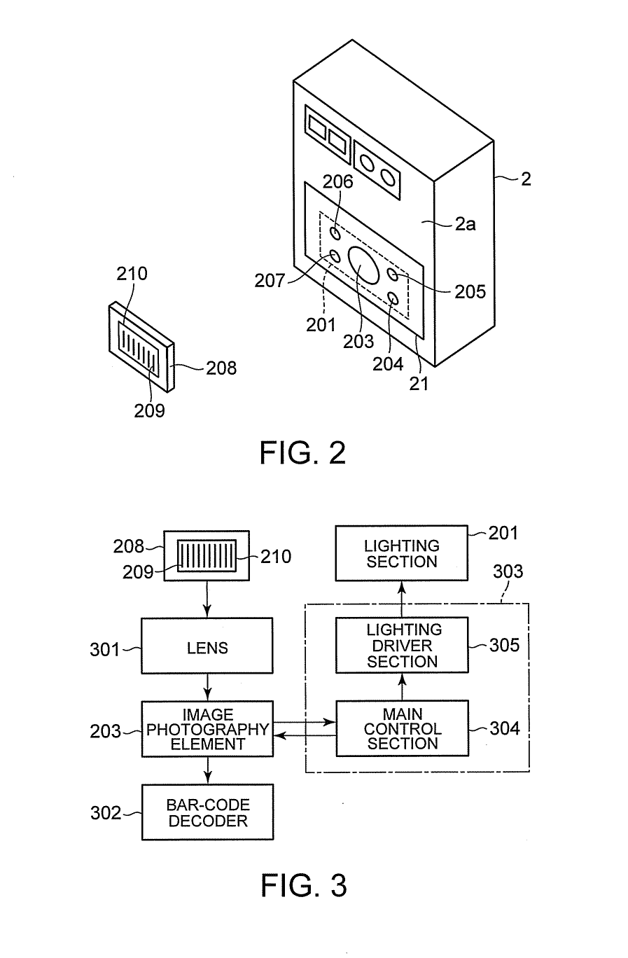

An image photography element 203 (shown in FIG. 2) is arranged in the inside of the code symbol reading apparatus 2 in which the read-out window 31 is provided. The image photography element 203 may be a CCD (Charge Coupled Device) image sensor or other image sensors such as, e.g., CMOS (Complementary Metal Oxide Semiconductor) image sensor. The image photography element 203 photographs a bar-code affixed on an article which is held at an image photography area formed at outside of the read-out window 21.

FIG. 2 is an external perspective view showing a structure of the code symbol reading apparatus according to the first embodiment. As shown in FIG. 2, the code symbol reading apparatus 2 equips with the image photography element 203 and a lighting section 201 at its front side 2a. The article 208 is held at the image photography area of the image photography element 203. A sheet 210 on which a bar-code 209 is printed is affixed on the article 208. When the bar-code is read out by the code symbol reading apparatus 2, the operator adjusts the location of the article to the read-out window 31 such that the bar-code 209 affixed on the article is moved to position within the image photography area of the image photography element 203.

The image photography element 203 photographs the bar-code 209 printed on the sheet 210 affixed on the article 208 which locates apart from the front side 3a of the code symbol reading apparatus 2. The code symbol reading apparatus 2 receives light reflected from the bar-code 209 and the article 208 and converts the reflected light to an electric data to out put it as an image data of the article 203. In the present embodiment, the image photography element 203 out puts an XGA (Extended Graphics Array) image data whose resolution is 1024×768 pixels.

The lighting section 201 serves as a light source which radiates light to the image photography area of the image photography element 203. In this embodiment, the lighting section 201 is comprised of four light-emitting diodes 204, 205, 206 and 207 arranged at the circumference of the image photography element 203. The lighting section 201 has a radiation area of light similar to or wider than the image photography area of the image photography element 203.

In this embodiment, the lighting section 201 radiates light for a prescribed period in synchronism with a period that an image (bar-code) is photographed by the image photography element 203. In addition, the lighting section 201 also radiates light for a prescribed period at prescribed intervals while image is not photographed by the image photography element 203.

FIG. 3 is a block diagram illustrating a structure of the code symbol reading apparatus 2 of the present embodiment. The code symbol reading apparatus 2 has a lens 301. The image photography element 203 photographs an image focused on the lens 301 and outputs it as an image data.

A bar-code decoder 302 shown in FIG. 3 is connected to the image photography element 302 to capture the image data output from the image photography element 203. Further, the bar-code decoder 302 extracts an image of the bar-code 209 contained in the captured image data to decode the extracted image (bar-code) and thus acts as a code reading section that reads article information relating to the article on which the bar-code is affixed.

A control section 303 includes a main control section 304 and a lighting drive section 305 to control the photography of image by the image photography element 203 and radiation of light by the lighting section 201. The main control section 304 includes a CPU (Central Processing Unit), RAM (Random Access Memory), ROM (Read Only Memory) and an I/O port. As shown in FIG. 3, the main control section 304 is connected to the image photography element 203 and the lighting drive section 305 through a bus to control operations of the image photography element 203 and lighting drive section 305. In the concrete, the main control section 304 outputs a strobe signal instructing the photography of image to the image photography element 203 at prescribed intervals to control the photography of image by the image photography element 203. Also, the main control section 304 outputs a light control signal instructing radiation of light to the lighting drive section 305 to control radiation of light by the lighting section 201 through the lighting drive section 305. The lighting drive section 305 drives the lighting section 201 according to the light control signal output from the main control section 304 to make the lighting section 201 perform radiation of light.

Next, the structure and functions of the code symbol reading apparatus 2 realized with a program executed by the CPU of the main control section 304 will be described.

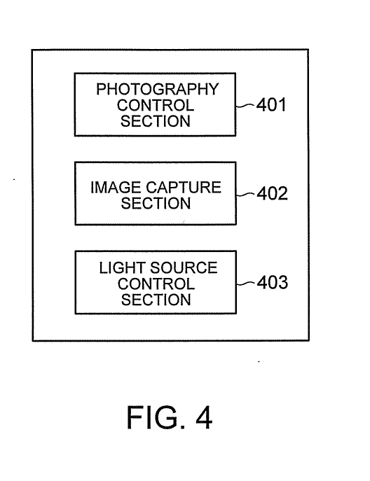

FIG. 4 is a block diagram showing structures which perform functions of the code symbol reading apparatus 2 according to the first embodiment. The CPU of the main control section 304 operates according to the program, stored in the ROM, which is developed on the RAM, and functions as a photography control section 401, an image capture section 402 and a light source control section 404, as shown in FIG. 4.

The photography control section 401 outputs a strobe signal to the image photography element 203 in synchronism with the falling edge of waveform of a horizontal drive signal HD generated by an outside circuit and controls the image photography by the image photography element 203.

The image capture section 402 captures, in synchronism with the horizontal drive signal HD and vertical drive signal VD generated by the outside circuit, image photographed by the image photography element 203. In the concrete, the image capture section 402 starts capture of one frame image from the image photography element 203 in synchronism with the falling edge of waveform of the vertical drive signal VD. When image is captured from the image photography element 203, the image capture section 402 captures image of one line unit in synchronism with the falling edge of waveform of the horizontal drive signal. HD. In the present embodiment, since an image having resolution of 1024×768 pixels is photographed by the image photography element 203, the image capture section 402 captures image having at least 768 lines (for example 791 lines) in synchronism with the falling edge of waveform of the horizontal drive signal HD. The image capture section 402 captures image having 1270 pixels in synchronism with a clock signal (clock signal of at least 1024 pixels, e.g., 1270 pixels) inputted between the falling edge and the next falling edge of waveform of the horizontal drive signal HD, when the one line image is captured.

The light source control section 403 outputs a light control signal to the lighting drive section 305 in synchronism with at least a part of period that the strobe signal from the photography control section 401 is output and controls radiation of light by the lighting section 201. Image is photographed by the image photography element 203 within a period during which the strobe signal is output. In addition, the light source control section 403 outputs the light control signal to the lighting drive section 403 at prescribed intervals while the strobe signal is not output from the photography control section 401 and controls radiation of light from the lighting section 201. Photography of image by the image photography element 203 is not performed within a period during which the strobe signal is not output.

The light source control section 403 executes a brightness judgment process that whether or not brightness of the captured image is equal to or greater than a pre-set brightness value when image of one frame is captured by the image capture section 402.

In the present embodiment, the light source control section 403 firstly calculates the number of white pixels, e.g., luminance of each RGB greater than 250, included in the captured image when the image capture section 402 captures image of one frame. And then, the light source control section 403 determines that brightness of the captured image by the image photography element 203 is equal to or greater than a pre-set brightness value when the calculated number of white pixels is equal to or greater than a pre-set number of white pixels, e.g., 1024×768/64 pixels or 1024×768/4 pixels.

In the present embodiment, using the number of white pixels included in the image captured by the image capture section 402, the brightness judgment process is executed. However, it is not limited to the above. For example, the light source control section 403 may execute the brightness judgment process, using a gradation data of image of one frame captured by the image capture section 402. In the concrete, the light source control section 403 seeks an averaged gradation data of the captured image when image is captured by the image capture section 402. Further, the light source control section 403 judges brightness of the captured image is greater than the pre-set brightness value when a value of the averaged gradation data is equal to or greater than a prescribed value of the gradation data.

The light source control section 403 shortens a period that the light control signal is output in synchronous with at least a part of a period for which the strobe signal is output from the photography control section 401 when the light source control section 403 judges that brightness of the image captured by the image capture section 402 is greater than the pre-set brightness value. Thus, a lighting adjustment process is executed such that the period that light is radiated from the lighting section 201 in synchronism with at least a part of the period that image is photographed by the photography section 203 is shortened from a first prescribed period of a usual case or a usual time described later.

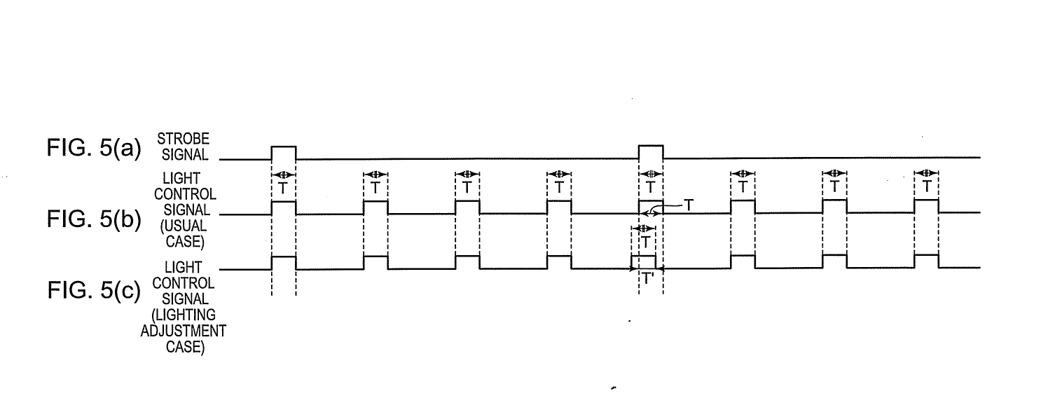

FIG. 5 is a timing chart respectively illustrating output timings of a strobe signal output from the main control section 304 and a light control signal output from the light source control section 403. FIG. 5(a) is a timing chart showing an output timing of the strobe signal and FIG. 5(b) is also a timing chart showing an output timing of the light control signal in a usual case (usual time) that the lighting adjustment process is not performed. FIG. 5(c) is a timing chart showing an output timing of the light control signal in the lighting adjustment case (light control time) that the lighting adjustment process is performed. The timing chart shown in FIG. 5 is an example that the light source control section 403 outputs a light control signal during a period the same as the period T that the strobe signal is output from the photography control section 401.

In case that brightness of the captured image is smaller than the preset brightness value (usual case), as shown in FIGS. 5(a), 5(b), the light source control section 403 outputs a light control signal for a first prescribed period in synchronism with the strobe signal from the photography control section 401. In addition, the light source control section 403 also outputs the light control signal at prescribed intervals for a period that the strobe signal is not output from the photography control section 401. By this way, since the light control signal is output for a period T that the strobe signal is output, brightness of the image photographed by the image photography element 203 increases.

On the other hand, in case that it is judged that brightness of the captured image is equal to or greater than the preset brightness value, as shown in FIGS. 5(a), 5(c), the light source control section 403 starts output of the light control signal prior to the output of the strobe signal from the photography control section 401 (lighting adjustment process). Namely, the light source control section 403 starts radiation of light by the lighting section 201 before commencement of photography of image by the image photography element 203. By this way, since a period of output of the light control signal during the period that the strobe signal is output is shortened from the first prescribed period T to a second prescribed period T′, brightness of the image photographed by the image photography element 203 decreases. In addition, the light source control section 403 also outputs a light control signal at prescribed intervals during the period that the strobe signal is not output from the photography control section 401.

In the timing chart shown in FIG. 5, radiation of light from the lighting section 201 is advanced compared with that of the usual case when it is judged that brightness of the captured image is greater than the preset brightness value. However, it is not limited to the above. For example, the light source control section 403 may start output of the light control signal after the strobe signal is output from the photography control section 401. Namely, the light source control section 403 delays commencement of radiation of light from the lighting section 201 after commencement of photography of image by the image photography element 203 and thus a period that light is radiated in synchronism with at least a part of the period that image is photographed by the image photography element 203 is shortened from the first prescribed period.

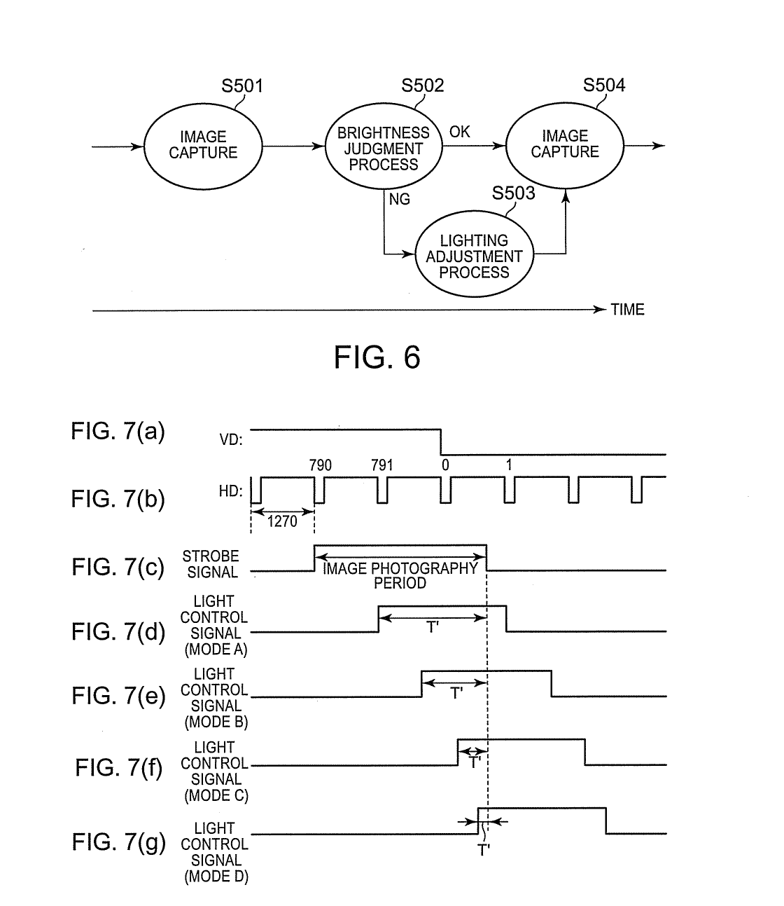

FIG. 6 is a view showing flow of an image capture process in the code symbol reading apparatus 2 according to the first embodiment. The image capture section 402 captures image of one frame photographed by the image photography element 203 in synchronism with the horizontal drive signal HD and vertical drive signal VD when image is photographed by the image photography element 203 (S501).

The light source control section 403 executes a brightness judgment process which judges whether or not brightness of a captured image is greater than the preset brightness value when image of one frame is captured by the image capture section 402 (S502). In the brightness judgment process, the lighting adjustment process is not performed by the light source control section when it is judged that brightness of the captured image is smaller than the preset brightness value (OK of S502). The image capture section 402 further captures a new image photographed by the image photography element 203 in synchronism with the horizontal drive signal HV and vertical drive signal (S504).

On the other hand, in case that it is judged that brightness of the captured image is greater than the preset brightness value (NG of S502), the light source control section performs the lighting adjustment process in which a period that the light control signal is output in synchronism with at least a part of a period that the strobe signal is output from the photography control section 301 is shortened (S503). And then, the image capture section 402 captures image photographed by the image photography element 203 in synchronism with the horizontal drive signal BD and vertical drive signal VD after the lighting adjustment process is executed (S504).

As described above, according to the code symbol reading apparatus of the first embodiment, in case that brightness of the captured image (bar-code) is greater than the preset brightness value, brightness of the image can be changed without changing intensity of light radiated to the photography area of the image by shortening from the prescribed period a period that light is radiated in synchronism with at least a part of the period that image is photographed. Therefore, brightness of an image photographed can be changed when image is photographed keeping human's eyes under the illusion that light is always radiated.

### Second Embodiment

In the second embodiment, in case in which brightness of the captured image is greater than the preset brightness value, a period that light is radiated in synchronism with at least a part of the period that image is photographed is shortened from the prescribed period according to the number of white pixels contained in the captured image.

The light source control section 403 of the second embodiment shortens from the prescribed period a period that light is radiated in synchronism with at least a part of the period that image is photographed based on the number of white pixels included in the captured image in case in which brightness of the image captured by the image capture section 402 is greater than the preset brightness value. In the concrete, the light source control section 403 shortens a period that light is radiated in synchronism with at least a part of the period that image is photographed by the image photography element 203 as the number of white pixels included in the captured image increases in case in which brightness of the image captured by the image capture section 402 is greater than the preset brightness value.

In the second embodiment, as shown in FIG. 7, the light source control section 403 selects a mode from four preset lighting modes (mode A, mode B, mode C and mode D) according to the number of white pixels NWP contained in the captured image in case that brightness of the captured image by the image capture section 402 is greater than the preset brightness value. Next, the light source control section 403 shortens a period that light is radiated in synchronism with at least a part of the period that image is photographed by the image photography element 203 according to the number of white pixels NWP contained in the captured image by outputting the light control signal based on the selected lighting mode.

FIG. 7 is a timing chart showing timings which respectively output light control signals according to the four lighting modes. As described in the first embodiment, the photography control section 401 outputs a strobe signal to the image photography element 203 in synchronism with the falling edge of the horizontal drive signal HD generated by an outside circuit.

Hereinafter, selection from the four preset lighting modes will be explained.

(1) The light source control section 403 selects the mode A in which a period T′ that the light control signal is output is longest during the period that the strobe signal is output in case that image photographed by the image photography element 203 is not captured or brightness of the captured image is smaller than the preset brightness value in the brightness judgment process.

(2) In a state that the light control signal is output according to the mode A, the light source control section 403 selects the mode B in which a period T′ that the light control signal is output is shorter than the mode A during the period that the strobe signal is output in case that brightness of the captured image is greater than the preset brightness value.

(3) In a state that the light control signal is output according to the mode B, the light source control section 403 selects the mode C in which a period T′ that the light control signal is output is shorter than the mode B during the period that the strobe signal is output in case that brightness of the captured image is greater than the preset brightness value.

(4) In a state that the light control signal is output according to the mode C, the light source control section 403 selects the mode D in which a period T′ that the light control signal is output is shortest during the period that the strobe signal is output in case that brightness of the captured image is greater than the preset brightness value.

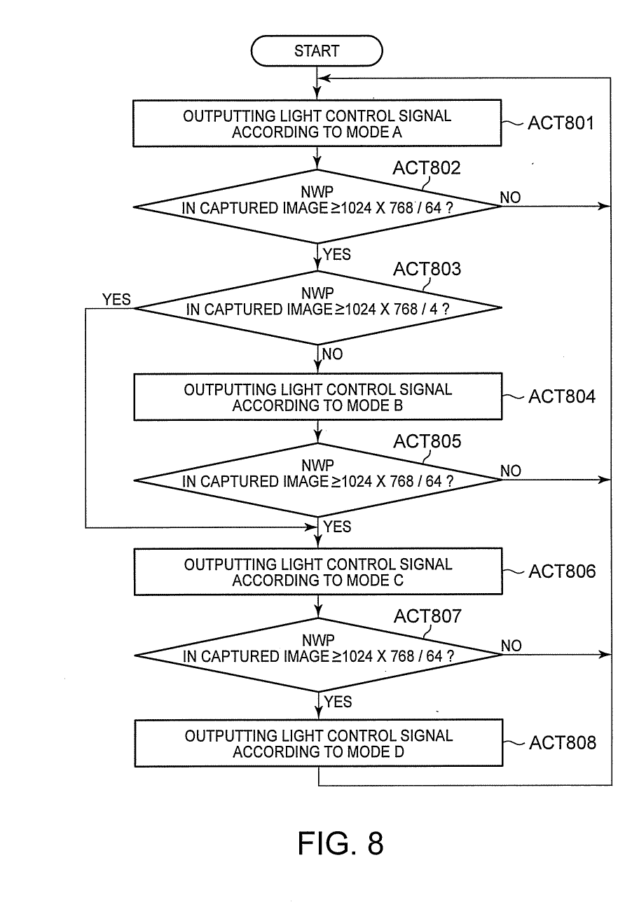

FIG. 8 is a flow chart showing a flow of process in which a code symbol is captured in a code symbol reading apparatus 2 according to the second embodiment. The light source control section 403 selects a lighting mode A and outputs a light control signal according to the mode A (ACT801). The image capture section 402 captures image of one frame that is photographed when the light control signal is output. The light source control section 403 judges whether or not the number of white pixels NWP contained in the captured image is equal to or greater than 1024×768/64 pixels (ACT802). In case that it is judged that the number of white pixels NWP included in the captured image is smaller than 1024×768/64 pixels (No of ACT802), returning to the ACT801, the light source control section 403 outputs a light control signal according to the mode A.

On the other hand, in case that it is judged that the number of white pixels NWP contained in the captured image is equal to or greater than 1024×768/64 pixels (Yes of ACT802), the light source control section 403 judges whether or not the number of white pixels NWP contained in the captured image is equal to or greater than 1024×768/4 pixels (ACT803). In case that it is judged that the number of white pixels NWP contained in the captured image is smaller than 1024×768/4 pixels (No of ACT803), the light source control section 403 selects the lighting mode B and outputs a light control signal according to the mode B (ACT804). The image capture section 402 captures image of one frame when the light control signal is output according to the mode B. Then, the light source control section 403 judges whether or not the number of white pixels NWP contained in the captured image is equal to or greater than 1024×768/64 pixels (ACT805). In case that it is judged that the number of white pixels contained in the captured image is smaller than 1024×768/64 pixels (No of ACT805), returning to the ACT801, the light source control section 403 outputs a light control signal according to the mode A.

When it is judged that the number of white pixels NWP contained in the captured image is equal to or greater than 1024×768/64 pixels (Yes of ACT805), the light source control section 403 selects the lighting mode C and outputs a light control signal according to the mode C (ACT806).

Next, in the ACT807, when the light control signal is output according to the mode C and image is photographed, the image capture section 402 captures the photographed image of one frame and the light source control section 403 judges whether or not the number of white pixels NWP is equal to or greater than 1024×768/64 pixels. In case that it is judged that the number of white pixels NWP contained in the captured image is smaller than 1024×768/64 pixels (No of ACT807), returning to the ACT801, the light source control section 403 outputs a light control signal according to the mode A.

When the number of white pixels NWP contained in the captured image is equal to or greater than 1024×768/64 pixels (Yes of ACT807), the light source control section 403 selects the lighting mode D and outputs a light control signal according to the mode D (ACT808).

Besides, in the ACT808, when image is photographed while the light control signal is output according to the mode D and the photographed image is captured by the image capture section 402, the light source control section 403 returns to the ACT801 without executing the brightness judgment process as described above and outputs a light control signal according to the mode A.

In general, when light control signals are respectively output according to four lighting modes A ▪ D and a period in which images of four frames are photographed is passed, an operator locates a bar-code of next article 208 within the photography area of the image photography element 203. At this point, it is a high probability that the operator locates the bar-code of the next article at a position different from that of the former article whose bar-code has been photographed. For that reason, in this embodiment, the light control signal is output according to the lighting mode A immediately after the light control signal is output according to the lighting mode D. Therefore, image of bar-code of each article is always photographed under a suitable lighting condition.

As described above, according to the code symbol reading apparatus of the second embodiment, a period that light is radiated in synchronism with at least a part of the period that image is photographed is sequentially shortened according to the number of white pixels contained in the photographed image when brightness of the photographed image is equal to or greater than the preset brightness value. Therefore, an image of bar-code is always photographed under a suitable brightness even if bar-codes of respective articles are photographed at different positions, respectively.

As explained above, according to the first and second embodiments, brightness of the photographed image can be changed without being perceived by a person when image is photographed in a state in which person's eyes are under illusion that light is always radiated

Programs executed by the code symbol reading apparatus of the present embodiment are composed with modules including each function sections (photography control section 401, image capture section 402 and light source control section 403). An actual hardware is realized such that above each function sections are loaded on the main memory device and generated on the main memory device by reading the programs from the ROM and executing it by the CPU.

Programs executed by the code symbol reading apparatus of the present embodiment are provided such that the programs are stored in the ROM previously. It is not limited however to this. For example, the programs executed by the code symbol reading apparatus of the present embodiment may be provided such that it is stored in a computer readable memory medium, such as, CD-ROM, Flexible disk (FD), CD-R, DVD (Digital Versatile Disk) and so on, with a file of an installable format or an executable format.

Furthermore, the above-described programs may be provided such that they are stored in a computer connected to a network, e.g., Internet, and are then downloaded through the network. The above-described programs may also be provided through the network.

The present invention has been described with respect to specific embodiments. However, these embodiments have been presented by way of example only. Other embodiments based on the principles of the present invention should be obvious to those of ordinary skill in the art. Such embodiments are intended to be covered by the claims.

What is claimed is:

1. A code symbol reading apparatus comprising:
an image photography section configured to photograph image of a code symbol;
a reading section configured to read out the code symbol from the image photographed by the image photography section;
a light source configured to radiate light to an image photography area for a first prescribed period in synchronism with at least a part of a period during which image is photographed by the image photography section and radiate light to the image photography area for the first prescribed period at prescribed intervals while image is not photographed by the image photography section; and
a control section configured to set a period for which light is radiated to the image photography area in synchronism with at least a part of the period during which image is photographed by the image photography section to a second prescribed period shorter than the first prescribed period if brightness of image photographed by the image photography section is equal to or greater than a preset brightness value.

2. The apparatus according to claim 2, wherein the control section sets a period for which light is radiated in synchronism with at least a part of the period during which image is photographed by the image photography section to the second prescribed period such that commencement of light radiation from the light source is advanced prior to commencement of image photography by the image photography section if brightness of image photographed by the image photography section is equal to or greater than the preset brightness value.

3. The apparatus according to claim 2, wherein the control section judges that brightness of image photographed by the image photography section is greater than the preset brightness value if number of white pixels contained in image photographed by the image photography section is equal to or greater than a prescribed number of pixels.

4. The apparatus according to claim 3, wherein the control section sets a period for which light is radiated in synchronism with at least a part of the period during which image is photographed by the image photography section to the second prescribed period according to the number of white pixels contained in image photographed by the image photography section if brightness of image photographed by the image photography section is equal to or greater than the preset brightness value.

5. The apparatus according to claim 2, wherein the control section judges that brightness of image photographed by the image photography section is equal to or greater than the preset brightness value if an average gradation of image photographed by the image photography section is smaller than a preset gradation value.

6. The apparatus according to claim 1, wherein the control section sets a period for which light is radiated in synchronism with at least a part of the period during which image is photographed by the image photography section to the second prescribed period such that commencement of light radiation from the light source is delayed after commencement of image photography by the image photography section if brightness of image photographed by the image photography section is equal to or greater than the preset brightness value.

7. The apparatus according to claim 6, wherein the control section judges that brightness of image photographed by the image photography section is greater than the preset brightness value if number of white pixels contained in image photographed by the image photography section is equal to or greater than a prescribed number of pixels.

8. The apparatus according to claim 7, wherein the control section sets a period for which light is radiated in synchronism with at least a part of the period during which image is photographed by the image photography section to the second prescribed period according to the number of white pixels contained in image photographed by the image photography section if brightness of image photographed by the image photography section is equal to or greater than the preset brightness value.

9. The apparatus according to claim 6, wherein the control section judges that brightness of image photographed by the image photography section is equal to or greater than the preset brightness value if an average gradation of image photographed by the image photography section is smaller than a preset graduation value.

10. The apparatus according to claim 1, wherein the second prescribed period includes plural target periods which are successively different in a period for which light is radiated in synchronism with at least a part of the period that image is photographed by the image photography section.

11. The apparatus according to claim 10, wherein the control section successively selects the second prescribed period from one target period that light is radiated in synchronism with at least a part of the period that image is photographed is longest to another target period that light is radiated in synchronism with at least a part of the period that image is photographed is shortest if brightness of image photographed by the image photography section is equal to or greater than the preset brightness value.

12. A method for reading a code symbol, including:
photographing an image of a code symbol;
capturing the code symbol from the photographed image;
radiating light to an image photography area for a first prescribed period in synchronism with at least a part of a period during which image is photographed and radiating light for the first prescribed period at prescribed intervals while image is not photographed; and
setting a period for which light is radiated in synchronism with at least a part of the period during which image is photographed to a second prescribed period shorter than the first prescribed period if brightness of image photographed is equal to or greater than a preset brightness value.

13. The method according to claim 12, wherein the second prescribed period includes plural target periods which are successively different in a period for which light is radiated in synchronism with at least a part of the period that image is photographed.

14. The method according to claim 13, wherein the second prescribed period is successively selected from one target period that light is radiated in synchronism with at least a part of the period that image is photographed is longest to another target period that light is radiated in synchronism with at least a part of the period that image is photographed is shortest if brightness of image photographed by the image photography section is equal to or greater than the preset brightness value.
